(19) United States
(12) Patent Application Publication
(10) Pub. No.: US 2010/0315020 A1
(43) Pub. Date: Dec. 16, 2010

(54) FURNISHING COMPLEMENT, IN PARTICULAR FOR HOUSE-ROOMS SEPARATION

(75) Inventor: Domenico Codoni, Chiari (IT)

Correspondence Address: Pearne & Gordon LLP, 1801 East 9th Street, Suite 1200, Cleveland, OH, 44114-3108, US

(73) Assignee: CHIARI BRUNO S.R.L., I-25032 CHIARI (BRESCIA) (IT)

(21) Appl. No.: 12/446,497

(22) PCT Filed: Oct. 24, 2007
(86) PCT No.: PCT/IB07/54326

§ 371 Date: Apr. 21, 2009

(30) Foreign Application Priority Data
Oct. 27, 2006 (IT) BS2006A000189

(51) Int. Cl. H05B 37/02; H05B 37/00

(52) U.S. Cl. 315/294; 315/312; 315/313

(57) ABSTRACT

A door, in particular for separating house rooms, equipped with a transparent portion (2) having a basically plate-like shape. A supporting cornice (5) is engaged to the transparent portion (2) and extends on the whole peripheral development of the transparent portion (2). Between said cornice (5) and the transparent portion (2) lighting means (9) are housed, for distributing a light ray inside said transparent portion (2).

The present invention relates to a furnishing complement, in particular for separating house rooms.

Preferably, the present invention can be advantageously used as a common partition door for houses.

As is known, partition doors can be provided inside with a transparent portion, generally supported by a cornice made of aluminum or wood, extending on the whole peripheral development of said transparent portion.

The cornice is basically rectangular in shape and is supported by way of suitable hinges on a frame (door-post) connected to the wall, so as to shift between a closed and an open position.

The transparent portion, generally made of glass, can be pacified or adequately treated, so as to suit the colour of said portion to the furniture surrounding the door.

In other words, depending on the various aesthetic furnishing needs, a transparent portion having specific chromatic features is used so as to obtain a global high-quality aesthetic effect for the room.

However, such furnishing complement has an important drawback.

In particular, furnishing complements as described above are not versatile and adaptable to rooms having changeable aesthetic features.

As a matter of fact, should the furniture of a room be changed, the transparent portion should necessarily be replaced with a portion suiting the new aesthetic solution.

Under these circumstances, the door should be disassembled and replaced, with subsequent economic concerns and problems involving replacement times.

The aim of the present invention consists in solving the problem of the prior art by proposing a furnishing complement, in particular for separating house rooms, which can be adaptable to various aesthetic furnishing needs of the room.

In further detail, the aim of the invention consists in providing a furnishing complement, particularly for separating house rooms, which is versatile and modifiable without replacing any part of said complement.

These and other aims as shall be more evident from the following description are basically achieved by a furnishing complement, particularly for separating house rooms, comprising the characteristics of claim 1.

Further characteristics and advantages shall appear more evident from the detailed description of a preferred, though not exclusive embodiment of a furnishing complement according to the present invention.

Such description shall be disclosed in the following with reference to the accompanying figures, provided to a merely indicative and therefore non-limiting purpose, wherein:

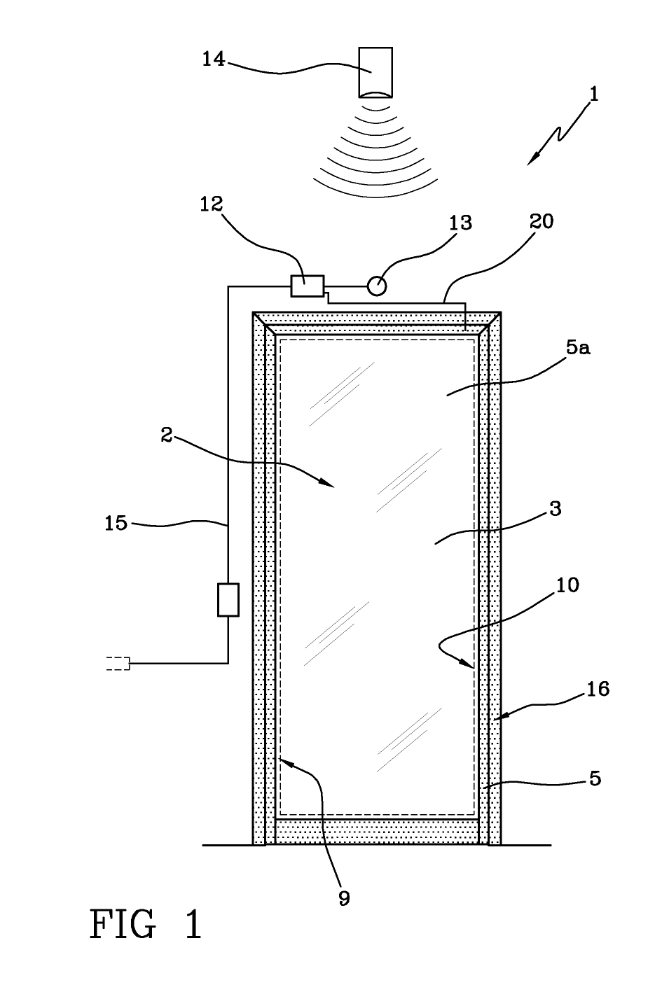

FIG. 1 shows a schematic view in front elevation of a furnishing complement according to the present invention;

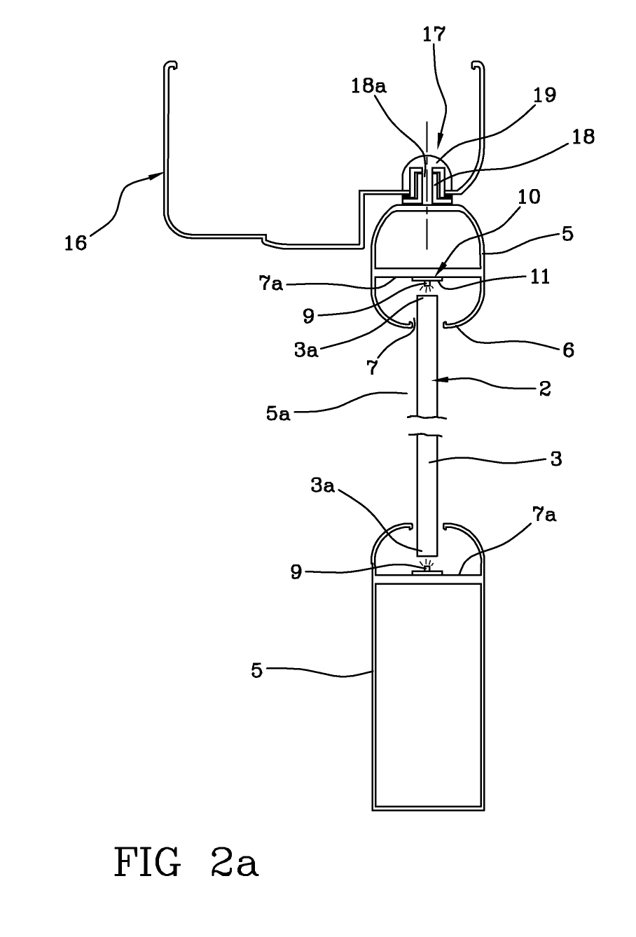

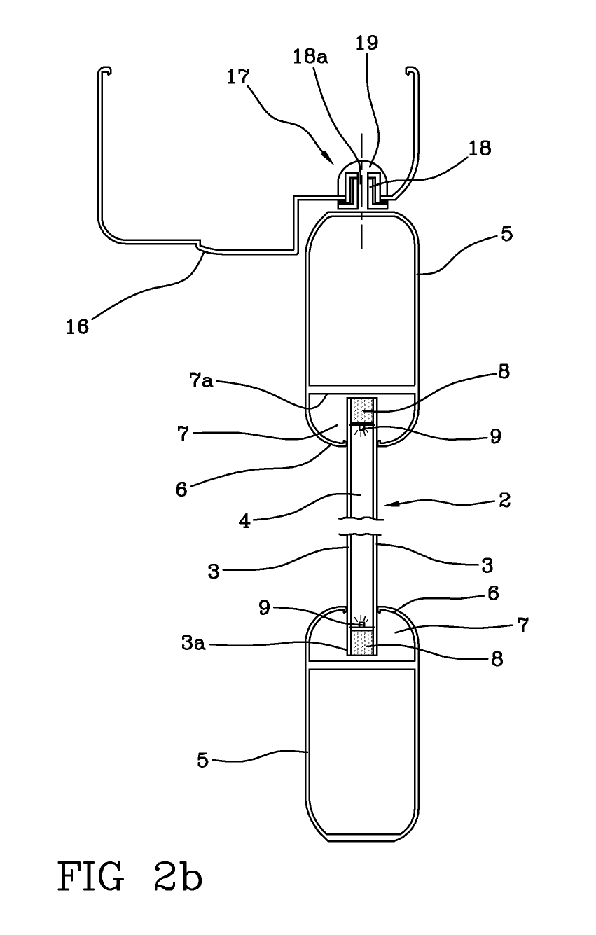

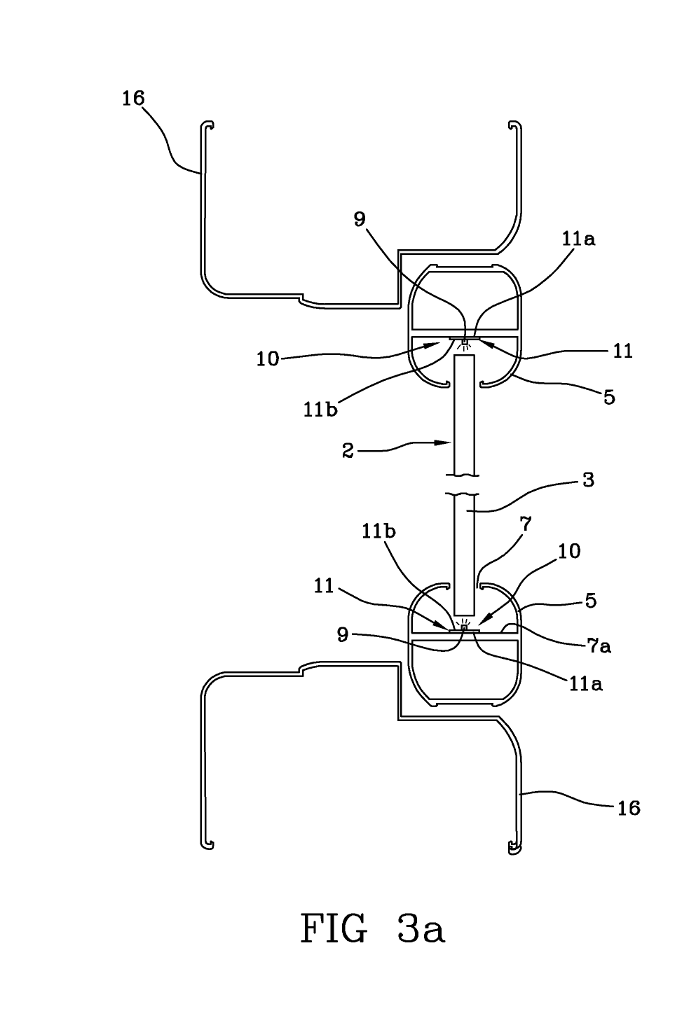

FIGS. 2a and 2b show schematic, vertically sectioned views of the furnishing complement of FIG. 1 according to respective execution variants;

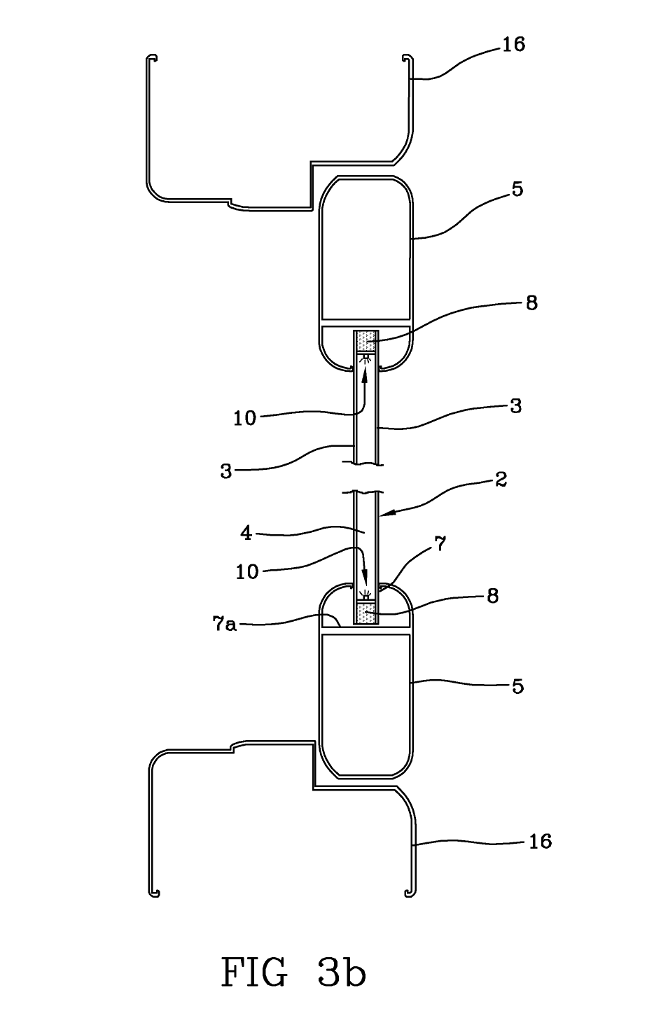

FIGS. 3a and 3b show schematic, horizontally sectioned views of the furnishing complement of FIG. 1 according to respective execution variants;

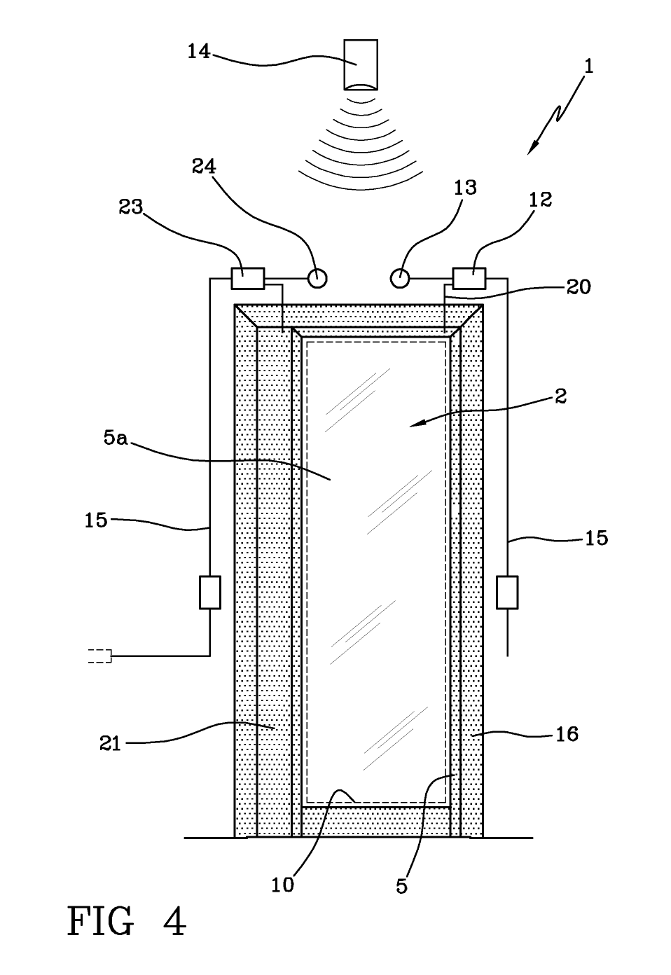

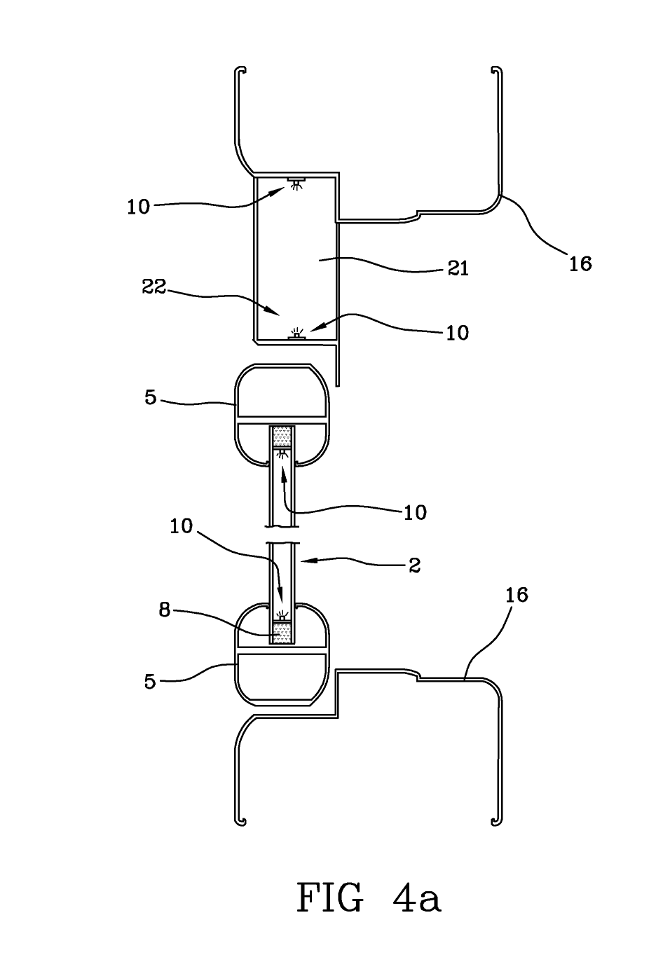

FIG. 4 shows a schematic view in front elevation of a furnishing complement according to a second solution; and

FIG. 4a shows a schematic, horizontally sectioned view of the furnishing complement of FIG. 4.

With reference to the figures mentioned above, the numeral 1 globally refers to a furnishing complement, particularly for separating house rooms.

The present invention can be advantageously used as a door associated to a wall generally made of brickwork.

Therefore, in the following description and in the accompanying figures reference shall only be made to a door.

However, it should be pointed out that the present invention can also be used as a fixed partition wall or as a partition wall that can be modified depending on the rooms to be separated.

With reference to FIG. 1, the furnishing complement 1 has a transparent portion 2, basically plate-shaped, designed to separate at least two rooms.

The transparent portion 2 can be made up of a panel 3 (FIGS. 2a, 3a) or two panels (FIGS. 2b, 3b), facing and spaced away from each other so as to define an inner compartment 4.

The panels 3 are preferably made of glass with toughened crystals or with multilayer toughened crystals (security glazing) for use, if necessary, in high-safety places.

Moreover, glass crystals can be translucent, with satin finish, etched or sandblasted for giving particular aesthetic effects to the transparent portion 2. The panels 3 can further have a glazed surface so as to block view from one side of the portion 2.

It should be pointed out that the accompanying figures show by way of example a portion 2, and the panels 3 constituting it, having a basically rectangular peripheral development. However, such portion 2 can have any shape or size.

The complement 1 further has a supporting cornice 5, preferably made of aluminum, engaged to said transparent portion 2 and extending on the whole peripheral development of said transparent portion 2.

In particular, the cornice 5 has a shape basically matching the peripheral development of the portion 2 and defines inside a housing compartment 5a inside which the portion 2 is arranged.

As is better shown in the sectioned views of FIGS. 2a, 2b, 3a and 3b, the cornice 5 has an inner surface 6 facing the portion 2 and on which a ring-shaped groove 7 is obtained, apt to contain the peripheral edge 3a of said panel 3.

As is shown in FIGS. 2a and 3a, in which the portion 2 as made up of one panel 3, the peripheral edge 3a faces an inner wall 7a of the groove 7.

With reference to FIGS. 2b and 3b, in which the portion 2 is made of two panels 3a instead, the groove 7 contains the peripheral edges 3a of both panels 3, which are spaced away from each other by way of a ring-shaped seal 8. Under these circumstances, the ring-shaped seal 8, preferably made of plastic, seals hermetically the inner compartment 4 and is arranged inside the groove 7 so as not to be seen from outside.

The complement 1 further comprises lighting means 9 placed between the cornice 5 and the transparent portion 2 so as to distribute light rays inside said transparent portion 2.

In further detail, the lighting means have at least one LED 10 of RGB type, apt to generate a light ray of various colours. Such type of LED 10 is commonly used in several technical applications and shall therefore not be described and disclosed in detail below.

Advantageously, the lighting means 9 are made up of a plurality of LEDs 10 of RGB type, placed one beside the other on the whole peripheral development of the transparent portion 2.

In accordance with the first solution of FIGS. 2a and 3a, the LEDs 10 face the peripheral edge 3a of the panel 3, whereas in the second solution of FIGS. 2b and 3b the LEDs are housed inside said inner compartment 4 defined by the two panels 3.

Preferably, the LEDs 10 are arranged on a ribbon-like support 11, shown only schematically and having a first surface 11a on which the LEDs 10 are housed, and a second surface 11b opposed to the first one 11a.

It should be noted that in the first solution of FIGS. 2a and 3a, the second surface 11b of the support 11 is connected to said inner wall 7a of the groove 7 and extends around the peripheral edge 3a of the panel 3.

In the second solution of FIGS. 2b and 3b, the second surface 11b of the support 11 is connected to the seal 8 and extends on the whole peripheral edge 3a of each panel 3.

Thus, the portion 2 is surrounded by a continuous row of LEDs 10, apt to light with respective light rays said portion 2.

The complement 1 further comprises an electronic processing central unit 12 electrically connected to the LEDs 10 so as to control said LEDs 10. In particular, the central unit 12, which is again of known type and shall therefore not be described in detail, switches on/off the LEDs and varies the light intensity and/or the colour of the light ray emitted in the portion 2.

Preferably, the central unit 12 is connected to a receiver 13 of infrared signals, which manages said central unit 12. The receiver 13 is operatively connected to an emitter 14 of infrared signals such as for instance a remote control for controlling from a certain distance the light emission generated by said LEDs 10.

The central unit 12 is further connected to an electricity grid 15 such as for instance the household distribution network.

Advantageously, as mentioned above, the complement 1 is used as door associated to a wall.

In particular, as shown in FIG. 1, the complement 1 is further equipped with a fixed frame 16 preferably connected on an opening obtained a partition wall, which is not shown in the accompanying figures since it is not part of the present invention.

Under these circumstances, the fixed frame 16 constitutes the doorpost, whereas the cornice 5 and its portion 2 constitute the moving part of said door.

The fixed frame 16 is engaged by way of a suitable hinge 17 to the cornice 5 so as to enable said cornice 5 and its transparent portion 2 to shift between a closed position in which they block the opening made in the wall, and an open position in which such opening is free.

In further detail, the hinge 17 is made up of at least one cylindrical pin 18 (FIGS. 2b, 3b) engaged to an upper area of the cornice 5 and turnably introduced into a recess 19 obtained in the fixed frame 16.

Thus, the cornice 5 and its portion 2 can be rotated around said pin 18 so as to shift said frame 5 between its open and closed position.

Preferably, the electronic central unit 12 and its receiver 13 are housed in the fixed frame 16 so as to make the cornice 5 and its transparent portion 2 lighter and handier.

Moreover, the central unit 12 is associated to the LEDs 10 by way of at least one cable 20 (schematically shown in FIG. 1) getting through a through recess 18a made in the cylindrical pin 18 and clearly shown in FIGS. 2a and 2b.

In accordance with another solution shown in FIGS. 4 and 4a, the fixed frame 16 can be equipped with at least one internally hollow portion 21. For instance, as is shown in FIG. 4, the internally hollow portion 21 can be made up of an additional upright of the fixed frame 16 and it is made at least partly of transparent material.

As is shown in the sectioned view of FIG. 4a, secondary lighting means 22 are housed inside the internally hollow portion 21, which means also are preferably made up of a plurality of LEDs 10 of RGB type.

The secondary lighting means 22 are electrically connected to a secondary electronic central unit 23 housed in the frame 16 and apt to vary the light intensity and/or the colour of the light ray emitted by the secondary lighting means 22.

Advantageously, also the secondary electronic central unit 23 includes a receiver of infrared signals 24 operatively connected to said emitter 14.

Thus, the emitter 14 controls the activation of both electronic central units 12, 23 so as to adjust the lighting means 9 and 22.

As a result, one control enables to vary lighting inside the portion 2 and inside the internally hollow portion 21. Stated otherwise, by way of the emitter 14 the LEDs 10 can be adjusted so as to provide a light with variable intensity and colour depending on the various aesthetic needs.

Advantageously, the complement 1 is highly versatile and adaptable to any room and furniture.

It should further be pointed out that the intensity and colour adjustment of the light ray emitted by the LEDs 10 does not require any replacement of structural components of the complement 1, with subsequent advantages in economic terms and concerning the time required for adjusting the aesthetic effect of said complement 1.

1-15. (canceled)

16. A door, in particular for separating house rooms, characterized in that it comprises:
a transparent portion (2) having a basically plate-like shape, for separating at least two rooms;
a supporting cornice (5) engaged to said transparent portion (2) and extending on the whole peripheral development of said transparent portion (2);
lighting means (9) placed between said cornice (5) and said transparent portion (2) for distributing a light ray inside said transparent portion (2);
a central unit (12) electrically connected to said lighting means (9) so as to control said lighting means (9);
a fixed frame (16) that can be associated to an opening obtained in a partition wall, and operatively coupled to the supporting cornice (5) for supporting said cornice (5) and its transparent portion (2);
a hinge (17) placed between said fixed frame (16) and said cornice (5) so as to enable said cornice (5) and its transparent portion (2) to shift between a closed position in which they block the opening made in the wall, and an open position in which said opening is free;
said hinge (17) including at least one pin (18) associated to an upper area of said cornice (5) and turnably introduced into a recess (19) obtained in said frame (16); said cornice (5) being turnable around the longitudinal axis of said pin (18);
at least one power cable (20) for connecting said lighting means (9) to said central unit (12);
said cable (20) developing in a through recess (18a) obtained in said pin (18).

17. The door according to claim 16, characterized in that said pin (18) is associated to a top edge of said cornice (5).

18. The door according to claim 16, characterized in that said lighting means (9) comprises a plurality of LEDs (10), arranged on the whole peripheral development of said transparent portion (2).

19. The door according to claim 18, characterized in that said transparent portion (2) comprises at least one panel (3); said LEDs (10) facing a peripheral edge (3a) of said panel (3).

20. The door according to claim 18, characterized in that said transparent portion (2) comprises two panels (3), spaced away from each other and defining an inner compartment (4);
said LEDs (10) being arranged in said inner compartment (4).

21. The door according to claim 18, characterized in that said LEDs (10) are associated to a ribbon-like support (11) having a first surface (11 a) on which said LEDs (10) are arranged, and a second surface (11 b) opposed to the first one (11 a) and connected to said supporting cornice (5).

22. The door according to claim 21, characterized in that said transparent portion (2) comprises at least one panel (3); said LEDs (10) facing a peripheral edge (3a) of said panel (3) and in that said supporting cornice (5) has an inner surface (6) having a basically ring-shaped groove (7) for housing the peripheral edge (3a) of said panel (3); said second surface (11 b) of the support (11) being connected to an inner wall (7a) of said groove (7).

23. The door according to claim 21, characterized in that said transparent portion (2) comprises two panels (3), spaced away from each other and defining an inner compartment (4); said LEDs (10) being arranged in said inner compartment (4) and in that said supporting cornice (5) has an inner surface (6) having a basically ring-shaped groove (7) for housing the peripheral edge (3a) of said panels (3); said second surface (11b) of the support (11) being connected to a ring-shaped seal (8) associated to the peripheral edges (3a) of the panels (3).

24. The door according to claim 18, characterized in that said central unit (12) is electrically connected to said LEDs (10) for varying the light intensity and/or the colour of the light ray emitted by said LEDs (10).

25. The door according to claim 24, characterized in that said central unit (12) comprises a receiver (13) of infrared signals, operatively connected to an emitter (14) of infrared signals, for controlling said central unit (12).

26. The door according to claim 16, characterized in that said central unit (12) is housed in said fixed frame (16).

27. The door according to claim 16, characterized in that said fixed frame (16) further comprises at least one internally hollow portion (21) inside which secondary lighting means (22) are housed; said portion (21) being made at least partly of transparent material.

28. The door according to claim 27, characterized in that it further comprises a secondary electronic processing central unit (23), electrically connected to said secondary lighting means (22) for varying the light intensity and/or the colour of the light ray emitted by said secondary lighting means (22).

29. The door according to claim 28, characterized in that said secondary electronic central unit (23) comprises a receiver of infrared signals (24) operatively connected to an element (14) emitting infrared signals, for controlling said secondary electronic central unit (23).

30. A partition wall having an opening, the edges of said opening being associated to said fixed frame (16) of the door according to claim 16.

31. The door according to claim 16, wherein said central unit (12) is an electronic processing central unit.

32. The door according to claim 18, wherein said central unit (12) is an electronic processing central unit.

33. The door according to claim 18, wherein said central unit (12) is for switching on/off the LEDs.

34. The door according to claim 18, wherein said LEDs are of RGB type.

35. The door according to claim 24, wherein said LEDs are of RGB type.
